(19) United States
(12) Patent Application Publication
(10) Pub. No.: US 2003/0139971 A1
(43) Pub. Date: Jul. 24, 2003

(54) System and method for automating a purchase approval process

(75) Inventors: Ronald Clifford Rescigno, Westlake Village, CA (US); Steven D. Rizzi, Annapolis, MD (US)

Correspondence Address: FOLEY AND LARDNER, SUITE 500, 3000 K STREET NW, WASHINGTON, DC, 20007, US

(73) Assignee: Edulink, Inc.

(21) Appl. No.: 10/050,115

(22) Filed: Jan. 18, 2002

(51) Int. Cl. G06F 17/60

(52) U.S. Cl. 705/26

(57) ABSTRACT

An automatic purchase approval process facilitates the selection of products to be purchased and obtaining approval for the purchase. In the process content is selected from a database to be included in an instructional material, which then identifies products available for purchase that are associated with the selected content. After selecting at least one of the identified products, a request for purchase is created for each of the at least one of the identified products. The request for purchase is transmitted to an approval organization, and an indication of whether the request for purchase was approved by the approval organization is then received.

### FIELD OF THE INVENTION

The present invention relates generally to automating a purchase approval process, and more particularly to a system and method for identifying products associated with content for an instructional material, selecting products for purchase, and automatically creating a request for purchase based on the selection that is submitted to an approval organization.

### BACKGROUND OF THE INVENTION

When developing a curriculum, whether it be for educational or training classes, there are typically a variety of materials that may be used as part of or to supplement the curriculum. For example, a class on geography might be enhanced by purchasing a globe or an atlas. Similarly, a computer training class might be enhanced by software used to supplement a student's training outside of the classroom.

There are several challenges for the developer of the curriculum with respect to obtaining these materials to supplement the curriculum. A first of these challenges is to identify what types of materials are available. For example, a curriculum developer of a computer training class for a particular programming language might want to purchase software to be used by students outside of class to supplement their training. However, the developer may be unaware if such a product exists, and if it does, which companies to look for that might sell such software.

Another challenge faced by the developer concerns the ability of the developer to purchase the materials for supplementing the curriculum. For example, a school teacher may have a limited budget to purchase materials for a class that requires approval for any purchases that exceed the budget. To purchase materials that exceed the budget, the teacher must typically fill out a form identifying the materials to be purchased, the cost of the purchase, and reasons for the purchase. The form is then submitted to some form of review board or approval organization, such as the PTA, the school board, or some other group which provides funding to the school, including charitable organizations.

These challenges, when combined, result in many inconveniences for the developer of the curriculum. In particular, the challenges may result in various delays in preparing the curriculum, as well as the development of a less than complete curriculum.

### SUMMARY OF THE INVENTION

Briefly, a method consistent with the present invention for automating an approval process for a request for purchase receives a search query for identifying content from a database to be included in an instructional material, and identifies products available for purchase from the content in the database based on the search query. An indication to purchase at least one of the identified products is received, and a request for purchase is created for each of the at least one of the identified products. The request for purchase is transmitted to an approval organization, and an indication is received of whether the request for purchase was approved by the approval organization.

In another aspect of the invention, the request for purchase includes information regarding a cost for the purchase and information regarding the type of product.

### BRIEF DESCRIPTION OF THE DRAWINGS

FIG. 1 is a block diagram of an automatic purchase approval system consistent with the present invention.

FIG. 2 is a flow diagram of an automatic purchase approval process consistent with the present invention.

FIG. 3 is a screen shot of a graphical editing tool consistent with the present invention.

FIG. 4 is a flow diagram of an instructional material development process using the graphical editing tool of FIG. 3.

FIG. 5 is a flow diagram of a process for selecting a product in the process of FIG. 2.

FIG. 6 is a flow diagram of a process for selecting an approval group in the process of FIG. 2.

FIG. 7 is a flow diagram of a process for creating a request for purchase (RFP) in the process of FIG. 2.

FIG. 8 is a flow diagram of a process for storing product information in the automatic purchase approval system of FIG. 1.

### DETAILED DESCRIPTION OF THE PREFERRED EMBODIMENT

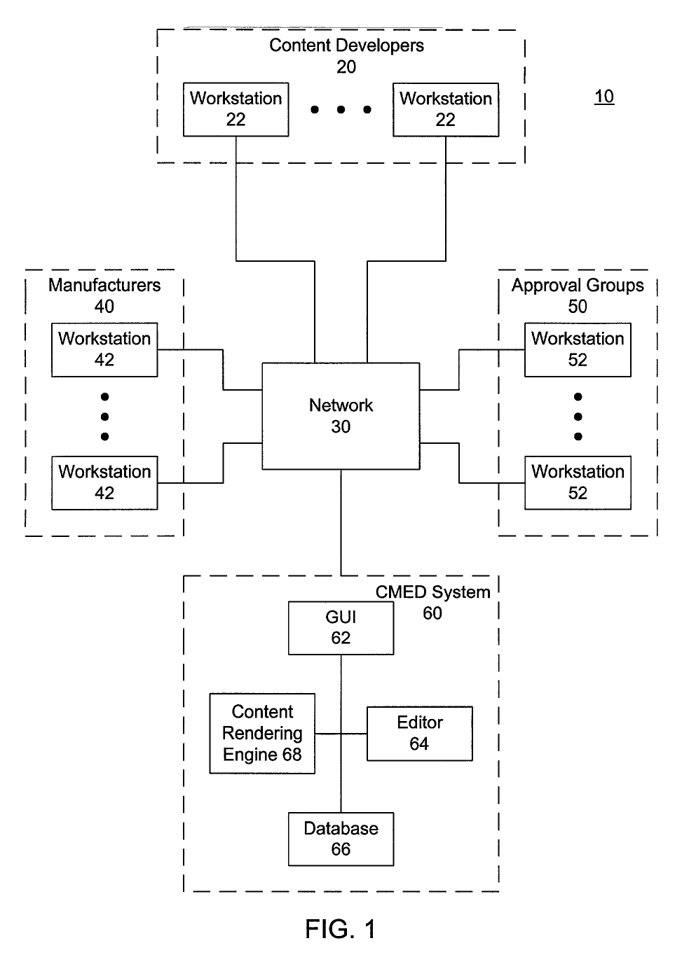

FIG. 1 is a block diagram of an automatic purchase approval system 10 consistent with the present invention. As shown in FIG. 1, the automatic purchase approval system 10 includes a group of content developers 20, a group of manufacturers 40, a group of approval groups 50 and a content management, editing and deliver (CMED) system 60. Although shown as a group, the blocks shown in FIG. 1 may include one or more content developers 20, one or more manufacturers 40 and one or more approval groups 50. The content developers 20, the manufacturers 40, the approval groups 50 and the CMED system 60 are all interconnected through a network 30. The manufacturers 40 include original equipment manufacturers, product distributors and retailers.

Within the group of content developers 20 are one or more workstations 22. Each workstation 22 may be implemented, for example, as a personal computer or other type of processing station. The workstations 22 may be part of a private network, such as a LAN or intranet. In addition, each of the workstations is coupled to the network 30, which may be implemented as a connection backbone to a plurality of different networks. The network 30 is preferably implemented as the Internet.

Like the group of content developers 20, the group of manufacturers 40 includes a plurality of workstations 42 and the group of approval groups 50 includes one or more workstations 52. The workstations 42 and 52 may implemented in the same manner as the workstations 22 and are each connected to the network 30. Although shown as being part of different groups, the workstations 22, 42 and 52 may be part of the same or different private network. In addition, a single workstation may be part of any combination of the groups of content developers 20, manufacturers 40 and approval groups 50.

The CMED system 60 includes a graphical user interface (GUI) 62, an editor 64, a database 66 and a content rendering engine 68. The CMED system 60 may be implemented, for example, as a server computer providing all of the functionality of the GUI 62, the editor 64, the database 66 and the content rendering engine 68. The functionality may be stored in a storage device in the server that is accessed by a processor to execute the functionality. Alternatively, the functionality of the GUI 62, the editor 64, the database 66 and the content rendering engine 68 may be distributed across multiple computers or multiple storage devices residing at one or more locations.

The GUI 62 provides an interface for the content developers 20, the manufacturers 40 and the approval groups 50 to use to access content stored in the database 66. The GUI may be implemented as a browser interface accessible to the content developers 20, the manufacturers 40 and the approval groups 50 via the Internet. The database 66 receives inputs through the GUI 62 and uses the inputs to access applicable content stored in the database 66. Content from the database 66 may be transformed for display to the content developer 20, the manufacturers 40 and the approval groups 50 by the content rendering engine 68. The content rendering engine 68 uses transforms, such as style sheets, to transform content from the database 66 into a viewable format. The style sheet is a set of rules for transformation of content into a desired form.

The editor 64 is a tool for the content developers 20 to edit content stored in the database 66. The editor 64 may also be used to edit content to be stored in the database 66 that has been imported from another location. The editor 64 is capable of editing content stored in a structure corresponding to the structure of the database 66. If the database 66 is implemented with XML (extensible markup language) structured content, the editor 64 may be implemented as XMetal 2.0, a product of Corel, Inc.

The database 66 is preferably implemented using technology which is supportive of semi-structured documents, i.e., is supportive of both limited field retrieval as well as text indexing. The content in the database 66 may be defined structurally with XML, although other embedded metadata languages may be used. For a database of XML structured content, the database 66 may be implemented using the Structured Information Manager (SIM), a commercial product of the Royal Melbourne Institute of Technology, or some other comparable XML database technology. In an XML implementation, each piece of information in the database 66 is associated with a series of tags, referred to as metatags, and the structure of the data is interspersed with the content by embedding the metatags with the content. These tags generally provide attribute information, including identification and classification information for the content. For example, a piece of content may include tags identifying the author of the content, the title, the type of content, such as text or images, and any other relevant information. The tags are editable fields that may be referred to for identifying content applicable to an instructional material.

The database 66 includes a data model, which is a set of constructs that provides a structure of the information in the database. More specifically, the data model identifies what the context is of any particular data element. For example, the data model may identify information using classifications, such as classrooms have students, students are a subclass of people, or a curriculum has units, lessons, activities and resources, each of which has attributes. The data model provides structure in the database for information such as user registration information and data or content information, such as text, images, video or audio information.

One part of the data model is the document type definition or DTD. The DTD defines the structure and context of documents in the database 66. Documents include the data or content information stored in the database 66, including text, images, video or audio information. The DTD includes a document descriptor, which defines the way in which the elements of the document are structured. For example, a lesson has subsections, the subsections have headings, etc. The DTD also defines the tags associated with the content.

To display the information stored in the database 66, the content rendering engine 68 may use a style sheet having formatting rules for transforming content in the database 66 into a displayable format. The style sheet may be an XSLT (extensible style language transformation) style sheet, to transform the content in the database 66. The style sheet includes a set of rules that are read by the content rendering engine 68 for rendering of content stored in the database 66.

The database 66 may be distributed among one or more servers or computers located in the same or disparate locations. In operation, a query may be submitted to the database 66, and the query is applied to each part of the database 66, such as through a network. In response to the query, a single unified result is provided to the user who submitted the query. Queries to the database 66 may be effected using the Z39.50 query protocol adopted as a standard by ANSI. Queries are preferably made in a contextual format.

Distributing the database 66 allows a greater amount of content to be accessible and searchable. Moreover, the creator and owner of the content may hold on to the content and control the access to the content. For example, the database 66 may be distributed to include images from a nationally distributed magazine, which are stored in a server for the nationally distributed magazine. The images are preferably stored in a database having the same data model as the database 66 and conforming to the same query protocol, although the data model of the database for the nationally distributed magazine may be mapped to the data model of the database 66 if their data models are different. By distributing in this manner, the operator of the database 66 may selectively license content, such as the images from the nationally distributed magazine, and allow users of the database 66 to have access to that licensed content, but only need to submit a single query to search that licensed content.

The content developer 20 operating at the workstation 22 can develop instructional material by accessing the CMED system 60 via the network 30. Instructional material, consistent with the present invention, may be defined as a conglomeration of structured content that is developed with the assistance of the CMED system 60. After developing the instructional material, the content developer 20 may save the instructional material in the database 66. To view the instructional material developed by the content developer 20, the viewer 50 at the workstation 52 can access the CMED system 60 via the network 30, search the database for the desired instructional material, and have the instructional material displayed.

The manufacturers 40 operating at the workstation 42 can develop content to be stored in the database 66 by accessing the CMED system 60 via the network 30 or existing product catalog information can be repurposed to adhere to the CMED data model. For the automatic purchase approval system 10, the manufactures 40 may develop content relating to products sold by the manufacturers 40. The products may be objects that are manufactured by the manufacturer 40 or may be services provided by the manufacturer 40. As will be discussed below, the manufacturers 40 can store content describing a product and designate attribute information that ties the content describing the product to content that may be used in an instructional material developed by the content developer 20. A picture or diagram of the product or service may also be prepared by the manufacturer 40.

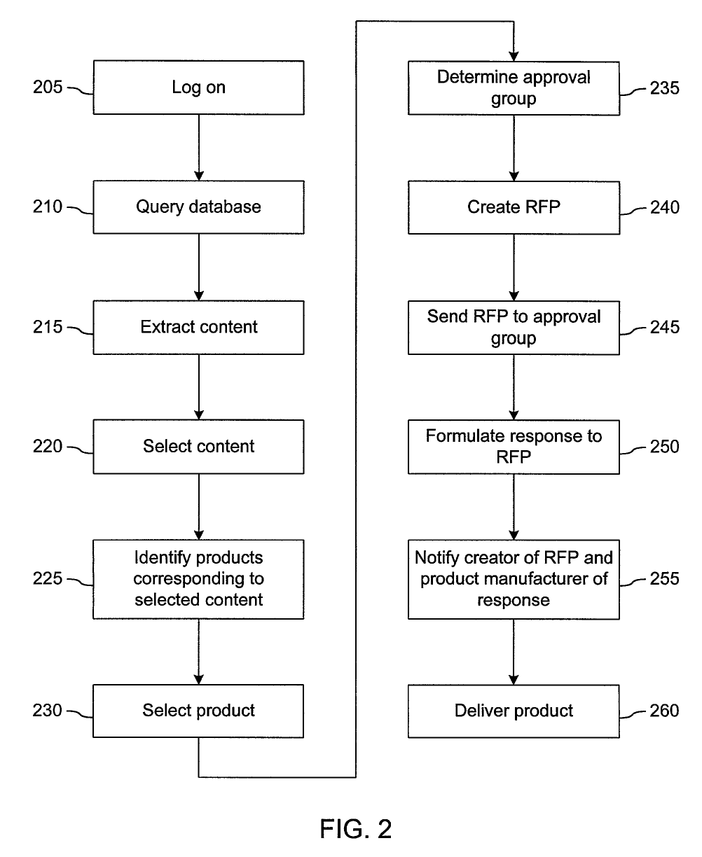

FIG. 2 is a flow diagram of an automatic purchase approval process consistent with the present invention. As shown in FIG. 2, the content developer 20 first logs into the CMED system 60 (step 205). If the network 30 is implemented as the Internet, then the content developer 20 may access the CMED system 60 via the World Wide Web. In such an implementation, the process of logging on to the CMED system 60 preferably includes a secure connection. For example, the CMED system 60 may require all of the content developers 20 to first register with the CMED system 60 before the functionality of the CMED system 60 may be used. The registration may require a fee to be paid to the party providing the CMED system 60. Subsequent to registration, the content developer 20 may be required to provide a user identification and a password before access to the content editor 40 is allowed. Alternatively, the network 30 may be implemented as a local private network that makes the CMED system 60 only accessible to content developers 20 that are part of the local private network.

After logging on to the CMED system 60, the content developer 20 opens an interface to the database 66. The interface to the database 66 is preferably implemented as the GUI 62. If the content developer 20 is developing a new instructional material, then the content developer 20 makes a selection through the GUI 62. The selection may be effected through the use of menus that provide the content editor 20 with options that may be selected with a pointing device, such as a mouse, or with a keyboard. Alternatively, if the content developer 20 is editing a previously existing instructional material, then the content developer 20 may use the menus to select an instructional material to edit.

Whether developing a new instructional material or editing an existing instructional material, the content developer 20 may use content from the database 66 to include in the instructional material. To locate content applicable to the instructional material being developed, the content developer 20 issues a query to the database 66 through the GUI 62 (step 210). The query may be implemented in a variety of formats. In one format, the query may have a variety of different fields that the content developer 20 may fill in as search criteria. For example, the query may have fields for authors, titles, topics, dates, or any other field that is useful in classifying content stored in the database 66. Alternatively, the query may be implemented in a natural language format or a Boolean format. The content developer 20 may also specify search criteria, such as words in the same paragraph or the same sentence, or within so many words from each other. In addition, the content developer 20 may submit an entire section of text as the query, such as a lesson plan, requesting that the CMED system 60 return samples of content in the database 66 which are similar to the section of text. The results of the search can come back with a Boolean matching or with a relevancy ranking.

After completing the query, the query is submitted to the database 66. The query is used to search the database 66 to extract applicable content (step 215). To identify the applicable content, the database 66 analyzes the submitted query and determines what type of content corresponds to the submitted query. If the database 66 is implemented in XML, the database 66 may search for content associated with tags corresponding to the content of the query. For example, if the query has fields for author and title that are filled-in in the query, the database 66 may identify content in the database 66 that has tags corresponding to the author and title identified in the query. In addition to searching the tags, the database 66 may search the content itself for terms corresponding to the information in the query. In the example of the title and author, the database 66 may identify text, such as articles, that refer to the title and author identified in the query.

Another search criterion that may be used by the content developer 20 is a standards criterion. A piece of content in the database 66 may have a standards attribute, which identifies a standard to which the piece of content conforms. The standard may be a national educational standard for a curriculum for grades K-12 or college, a standard for content used for training, such as for training in a computer language, or any other type of standard that identifies what content is acceptable. When developing an instructional material, a content developer 20 can refer to the standards attribute to determine whether or not the content in the instructional material conforms to a standard. For example, if the content developer 20 is developing a curriculum for a high school history class, the content developer can search for material that has a standards attribute for the standard applicable to the class, and use the content resulting from the search to form the curriculum.

The content in the database 66 that is identified in response to the search query is then provided to the content developer through the GUI 62. The content may be text, images, audio or video data. The identified content may be presented in a list in a window of the GUI 62, with each piece of identified content having some form of associated information describing the piece of content. For example, a picture of a president may be listed as “Picture of George Washington.” Each piece of identified content may also be associated with an icon that the content developer 20 can click on to view the piece of content and its associated attributes or tags.

From the list of content, the content developer 20 selects a piece of content to review to determine whether to include it in the instructional material (step 220). To review the content, the content developer 20 selects one of the pieces of content from the list, preferably through a mouse click. Reviewing the content gives the content developer 20 an opportunity to see the content before deciding whether or not the content is acceptable for the instructional material.

In addition to listing the pieces of content, a list of products corresponding to the search query is identified (step 225). The products and associated information are stored in the database 66 in the same manner as the other pieces of content. The products may be considered a subset of the content stored in the database 66, i.e., a particular content type. The products are identified based on the search query in the same manner as the pieces of content. All attributes of the product are evaluated for contextual relevancy to the user's query including, for example, the product name, description and category.

The products corresponding to the listed content are preferably products that are relevant to the listed content. For example, if the listed content is an article about a software product, the products corresponding to the listed content may include the software product itself, competing software products, and various hardware products that may be used in conjunction with the software product. To have a product correspond to the listed content, the content describing the product is stored in the database 66 with attribute information that ties the product to the query terms applicable to the listed content. Like the pieces of content, each listed product may be associated with an icon that the content developer 20 can click on to view the product, its relevant information and its associated attributes or tags.

Based on the list of products corresponding to the selected content, the content developer 20 may select a product to purchase (step 225). The content developer 20 may select a particular product for purchase using a pointing device or a keyboard entry. Alternatively, as will be described below, the content developer 20 may use a graphical editing tool. With the graphical editing tool, the content developer can drag the icon associated with a product into a workspace in which the instructional material is designed and edited.

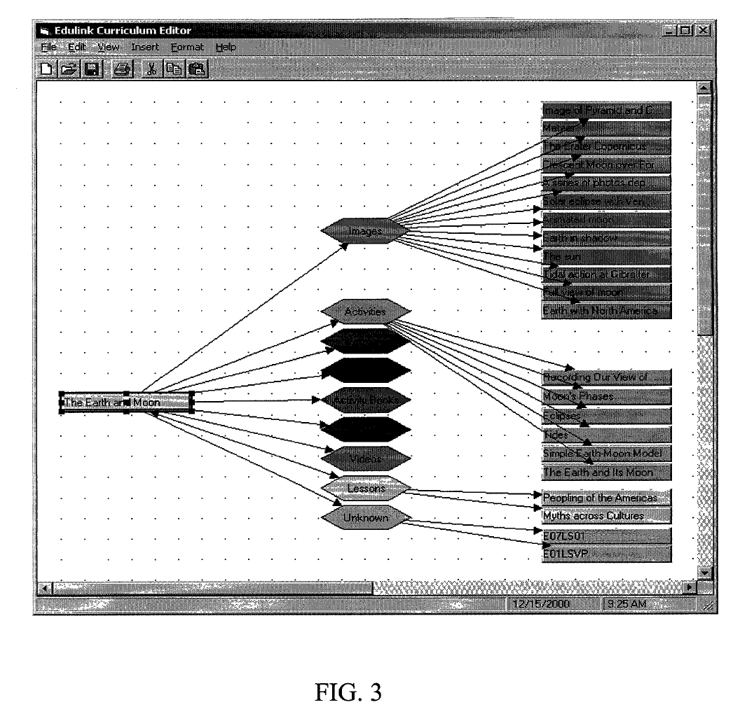

When creating the instructional material, the content developer 20 may use the graphical editing tool to help facilitate the design and structure of the instructional material. FIG. 3 is a screen shot showing a graphical structure of instructional material developed by a content developer 20. In the example of FIG. 3, the content developer has developed instructional material entitled “The Earth and Moon.” Linked to the instructional material are a plurality of types of content that may be included in the instructional material. The types of content include images, activities, web sites, audio, activity books, videos, lessons, and unknown (or miscellaneous). These content types are merely exemplary, and other content types or classifications may also be included, such as products.

Linked to each type of content are the specific pieces of content from the database 66 that are included in the instructional material. For example, the lessons include “Peopling of the Americas” and Myths Across Cultures.” The “Peopling of the Americas” and “Myths Across Cultures” may be textual materials stored in the database 66. These textual materials may also include or be linked to other types of content, such as images or activities.

The view shown in FIG. 3 is one example of the different inter-relationships between the content, the different types of content, and the instructional material. Other inter-relationships may also be shown. For example, the content developer 20 may request that the inter-relationships between the lessons and the other types of content be shown. In response to this request, the structure in FIG. 3 would show how the lessons are related or linked to any images or activities included in that lesson.

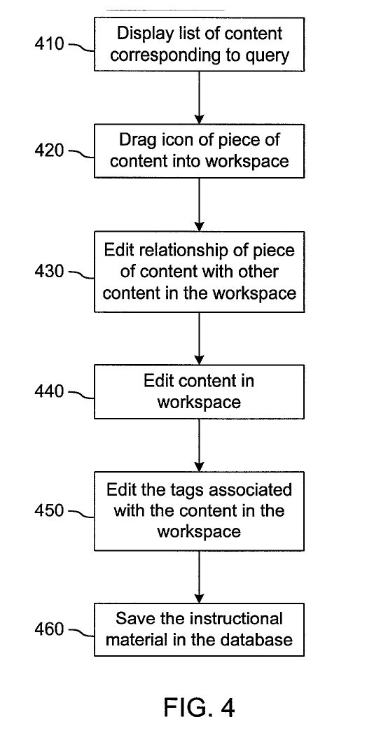

In addition to graphically displaying the various inter-relationships of the content and content types of the instructional material, the content developer 20 may use the graphical tool to add and edit the structure of the instructional material. FIG. 4 is a flow diagram of an instructional material development and product selection process using the graphical editing tool consistent with the present invention. As described above, after submitting a query, a list of content corresponding to the query is displayed to the content developer 20 (step 410). Each piece of content in the list, including any products, may have a corresponding icon.

To include a piece of content from the list in the instructional material, the content developer 20 drags the icon into a workspace provided by the graphical editing tool for the instructional material being developed (step 420). To drag the icon into the workspace, the content developer 20 can click on the icon corresponding to a selected piece of content with a mouse and drag the icon into the workspace.

After placing the icon in the workspace, the content developer 20 may edit the relationship or placement of the content corresponding to the icon with other content in the workspace (step 430). For example, the content developer 20 may want to have an image which has just been placed in the workspace to be included in a lesson. To do so, the content developer 20 creates a link between the icon for the image and the icon for the lesson. The link may be created by placing the icon for the image over the icon for the lesson. Alternatively, the content developer 20 may create the link by clicking on the icon for the image, and then use a feature from the graphical editing tool that allows the content developer 20 to draw the link between the icons.

After creating a relationship between pieces of content in the workspace, the content developer 20 may then edit a piece of content in the workspace (step 440). As described above, the content developer 20 may edit a piece of content, such as a lesson, by double clicking on the icon corresponding to the lesson, so that it appears in the editor 64. In addition to displaying the content of the lesson, the editor 64 displays any content that has been linked to the lesson, such as the just linked image. With the editor 64 open, the content developer 20 may edit the lesson and place the image just linked to the lesson at the specific location desired by the content developer 20.

In addition to editing the content, the relationships of the content, and the placement of the content, the content developer 20 may use the graphically displayed structure of the instructional material to edit the tags associated with the content (step 450). To edit the tags associated with a piece of content in the workspace, the content developer 20 may right click on the icon corresponding to the piece of content, which displays a menu from which the content developer 20 can select to view and edit the tags of the piece of content. In response to the selection, a window is displayed of all of the tags that are associated with the piece of content. The window may include a series of fields, each field corresponding to a respective one of the tags. The content developer 20 may change or edit any of these fields as desired.

The content developer 20 can also edit tags for the piece of content with the content displayed in the editor 64. With the content displayed in the editor 64, the content developer 20 may associate tags with particular portions of the content. For example, the content developer 20 may highlight a particular paragraph of the content and associate a viewer type attribute tag for the highlighted content.

When the content developer 20 has finished developing the instructional material, the content developer 20 saves the instructional material in the database 66 (step 460). The content developer 20 may designate who has access to the saved instructional material. For example, the content developer 20 may be an instructor who desires to have each of the students in the class to have access to the instructional material. Alternatively, the content developer may allow anyone registered in the CMED system 60 to have access to the instructional material.

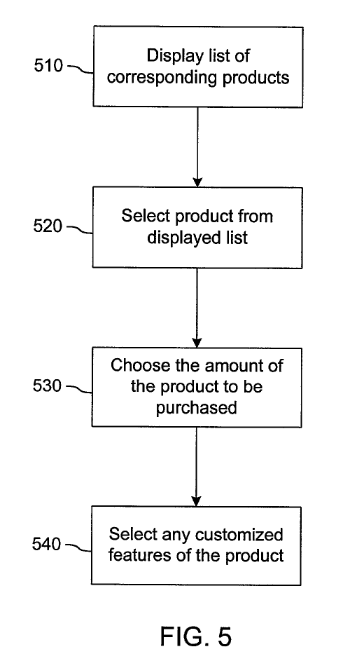

FIG. 5 is a flow diagram of a product selection process consistent with the present invention. As shown in FIG. 5, a list of products that may be purchased is displayed to the content developer 20 (step 510). The list of products may be shown in the same list as the list of other content from the database 66 identified by the search query or in a separate list. The list of products may be listed in order of relevancy to which the products correspond to the search query. Alternatively, the products may be listed alphabetically, by cost, or some other classification. Information in the list may include the title of the product, a description of the product, an image of the product, the cost, and any other information that may be relevant in determining whether to purchase the product. The information presented in the list depends upon the content stored in the database 66 describing the product.

Based on the list of products, the content developer 20 may select a product for purchase (step 520). The selection of the product may be effected, for example, through a mouse click. Alternatively, as described above, the icon corresponding to the product may be clicked on and dropped into the workspace of the graphical editing tool in which the instructional material is being developed. In addition to dragging the icon into the workspace, the content developer 20 may link the product to another icon in the instructional material. For example, for a book, the content developer 20 could drag the icon for the book into the workspace and then link that icon to a particular lesson in the instructional material related to the book.

The process of selecting a product for purchase may be described as “drag and buy.” This process facilitates the specification of how the product is intended to be used in the context of other materials and plans, since the graphical icon which represents the selected product is placed within the related content (e.g., a lesson plan). This graphical icon may be annotated to include a caption, which helps to describe how the product would be used in the intended setting.

In response to the selection of a product, the content developer 20 may choose the amount of the product to be purchased (step 530). To choose the amount of product to purchase, a window may appear in the GUI 62 prompting the content developer 20 to supply information regarding how much of the product to purchase.

In addition to choosing the amount to purchase, the content developer 20 may select any customized features of the product (step 540). The customized features may include various characteristics of the product including, for example, its size, speed, color or other feature of the product. The selection of the customized features may be done using a window of the GUI 62, which prompts to the content developer 20 to provide information about the customized features. The content developer 20 may also provide information about shipping, payment information or other information useful to complete the purchase of the product.

Returning to FIG. 2, a content developer 20, after selecting a product for purchase, may determine an approval group 50 for the purchase (step 235). Depending on the product being purchased, the content developer 20 may need to have approval for the purchase of the product from the approval group 50 before the purchase can be made. The approval group 50 is an organization that receives requests for purchases of products, provides either its approval or its denial of the requested purchase, and when providing its approval, may provide the funding for the purchase of the product. The approval group 50 may be a public organization, such as a school board, a parent teacher association (PTA) or a governmental organization, or a private organization, such as a company's executive board or a charitable organization. The approval group may also be the purchasing department for the teacher or the local administrator.

In one aspect of determining the approval group 50, a content developer 20 may be a school teacher developing an instructional material to be used for a geography class. While developing the curriculum using the CMED system 60, a list of products may be shown to the school teacher of various products corresponding to geographically related content, such as an atlas, a globe or a software program that may be used in conjunction with the curriculum. Before the product can be purchased, the school teacher may need to get approval from the approval group 50, such as the school board or PTA, particularly if the purchase would exceed a budget provided to the school teacher.

In another aspect, the content developer 20 may be an in-house computer trainer for a corporation developing an instructional material for training employees of the corporation on how to use certain software on the corporation's network. Using the CMED system 60 to develop the training instructional material, a list of products may be shown to the computer trainer of various products corresponding to the content related to the instructional material, such as textbooks, training manuals, or display devices, including projectors. Before the computer trainer can purchase a product to be used in conjunction with the training instructional material, the computer trainer likely must receive approval from a group in the corporation.

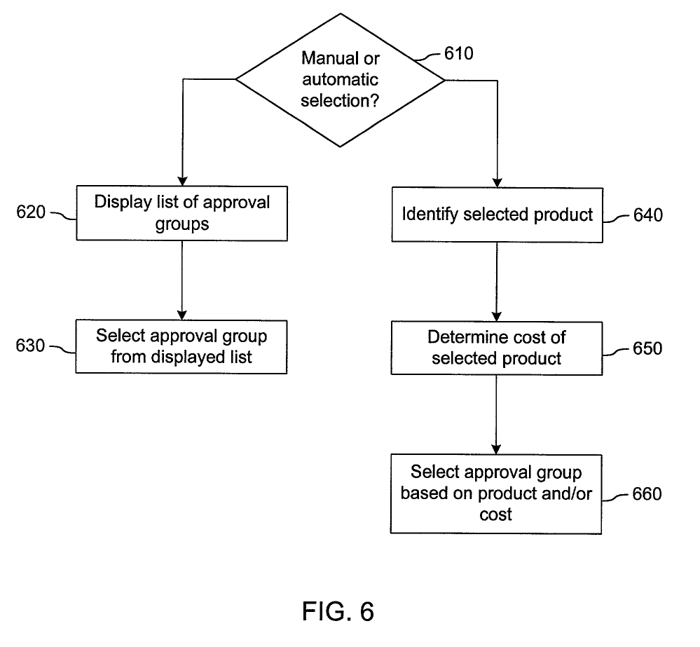

To determine the approval group 50, the content developer 20 may select it manually or the CMED system 60 may select it automatically. FIG. 6 is a flow diagram for determining an approval group 50 consistent with the present invention. As shown in FIG. 6, the content developer 20 has the option of selecting the approval group 50 manually or automatically (step 610). To make this selection, a window may appear in the GUI 62 prompting the content developer 20 to indicate with a mouse click whether the selection is to be made manually or automatically.

If the selection is to be made manually, a list of approval groups is displayed to the content developer through the GUI 62 (step 620). The list may include every possible approval group that has been registered in the database 66. Alternatively, the approval groups included in the list may be tied to the content developer 20. For example, a list for the school teacher may be limited to the school board or the PTA in the same locality as the school teacher. To identify a list limited to the content developer 20, attribute information associated with the content developer 20 may be used as search criteria applied to the database 66, which finds the approval groups 50 having attribute information corresponding to the attribute information of the content developer 20. The applicable attribute information may be, for example, the location of the content developer 20 or the type of content developer 20. After the list of the approval groups 50 is displayed, the content developer 20 selects which of the approval groups 50 is to be used to obtain approval for the purchase of the product (step 630).

If the selection is to be made automatically, the product selected for purchase is identified (step 640). The cost of the selected product is also determined (step 650). Based on the type of product, the cost of the product, as well as attribute information of the content developer 20, the approval group 50 is selected (step 660). As discussed above, applicable attribute information of the content developer 20 is matched against attribute information of the approval groups 50 in the database 66 to determine which of the approval groups 50 are applicable. Then based on the type of product and/or the cost of the product, the approval group 50 is selected. The type of product and its cost may affect what the approval group 50 is appropriate. For example, an inexpensive product selected by a school teacher may be appropriate for the PTA, but an expensive product may be appropriate for the school board.

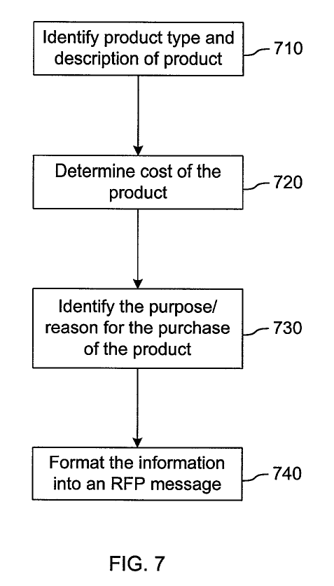

After determining the approval group 50, a request for purchase (RFP) is created (step 240). The RFP includes the information related to the product to be purchased and any other information relevant to the purchase that may help the approval group 50 evaluate whether or not to approve the purchase. FIG. 7 is a flow diagram of a process for creating an RFP consistent with the present invention. As shown in FIG. 7, the first step in creating the RFP is identifying the type of product and a description of the product (step 710). The description of the product may be obtained from information stored in the database 66 associated with the product. As will be discussed below, the descriptive information may be provided by the manufacturer 40 when it stores a product in the database 66.

In addition to the type and description of the product, the cost of the product is also determined (step 720). To determine the cost of the product, a cost attribute associated with the product is identified. The amount or quantity of product to be purchased, as discussed above in FIG. 5, is also identified. Then, based on the cost attribute and the amount of the product, the total cost of the product can be determined.

The content developer 20 may also provide information identifying a purpose or reason for the purchase of the product (step 730). This information allows the content developer 20 to describe how the product is to be used, how the product is useful for the instructional material being developed, why the product is needed for the instructional material, and any other information that may be useful in persuading the approval group 50 to approve the purchase of the product.

All of the information, including the type of product, a description of it, its cost, and the information regarding the reason for the purchase, is formatted into an RFP message (step 740). The manner in which the RFP message is formatted depends on how the RFP is to be transmitted to the approval group 50. For example, if the network 30 is implemented as the Internet, the RFP message may be formatted to conform to TCP/IP.

After the RFP message is created, it is sent to the approval group 50 that had been previously determined (step 245). The RFP message may be sent to a workstation 52 corresponding to the approval group 50. In particular, the RFP message may be sent from the CMED system 60 to the workstation 52 via the network 30. As discussed above, the format of the RFP message and the manner in which the message is sent to the workstation may depend on how the network 30 is implemented. For example, the format of the message and the manner in which it is sent may be different for the Internet versus a local network or different for wireless transmission versus wire or optical transmission. The message may be delivered at any time, regardless of whether or not the workstation 52 of the approval group 50 is logged onto the CMED system 60, for example, by sending the message by e-mail. Alternatively, the RFP messages may be stored in a queue designated for each approval group 50 in the CMED system 60 and retrieved by the approval group 50 when logged onto the CMED system 60.

The RFP message delivered to the approval group 50 is then analyzed by the approval group 50 to formulate a response to the RFP (step 250). The manner in which the RFP message is opened depends on how the RFP message was delivered to the approval group. For example, if the message is sent as an e-mail, the message may be opened by simply opening the e-mail. Alternatively, the message may be opened by a software application running on the workstation 52, which automatically searches for RFP messages received at the workstation and opens them for viewing. When the RFP message is opened, all of the information included in the message is displayed to the approval group 50, including a description of the product, its cost and reasons why the content developer wishes to purchase the product. Approval groups may be established which specify budgets for particular users of the CMED system. Such configurations would simply log the transaction, debit the amount from the user's budget, and order the product.

Once the approval group 50 has formulated a response to the RFP message, the approval group notifies the content developer 20 who created the RFP message and, depending on its response, the manufacturer 40 of the product to be purchased (step 255). To notify the content developer 20, a message may be sent directly to the content developer 20, such as by e-mail. Alternatively, a message may be sent back to the CMED system 60 in the same manner that the RFP message was delivered to the approval group 50 and stored in a queue associated with the content developer. The content developer 20 is notified by logging onto the CMED system 60 and opening the message from the queue. The substance of the message may be as simple as an indication of whether or not the RFP has been approved, or it may include details regarding the decision of the approval group 50 to approve or disapprove the purchase of the product.

If the approval group 50 has approved the RFP, then the manufacture 40 of the product that is the subject of the purpose is notified of the approval. This notification may include information from the RFP message sent to the approval group 50, including a description of the product and the cost. The notification also preferably includes purchasing information needed by the manufacturer 40 to process the purchase. The purchasing information may include, for example, how the product is going to be paid for, such as be check or credit card, when the product should be delivered, and to whom to deliver the product.

All of this information is sent to the manufacturer 40 as a purchase request from the approval group 50. The purchase request may be transmitted, for example, by e-mail or by other established electronic data interchange (EDI). Instead of sending the purchase request directly to the manufacturer 40, the responsibility for sending the purchase request may be given to the content developer 20, who sends a purchase request to the manufacture 40 of the product after receiving notification from the approval group 50 of the approval of the purchase. In response to the purchase request, the manufacturer 40 sends the product to the person or location indicated in the purchase request (step 260). This is particularly true if the content developer 20 is purchasing the product using their own credit.

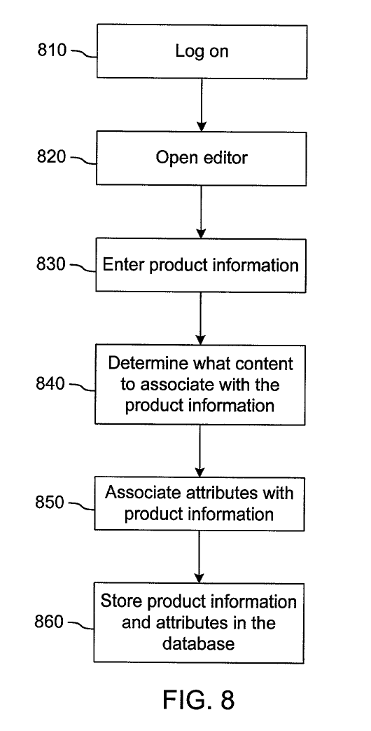

The manufacturer 40 may add or update product information in the database 66. FIG. 8 is a flow diagram of a product information storage process consistent with the present invention. As shown in FIG. 8, the manufacturer 40 first logs on to the CMED system 60 (step 810). Like the logging on step discussed in FIG. 2, the manufacturer 40 may access the CMED system 60 via the World Wide Web, preferably with a secure connection.

After logging on to the CMED system 60, the manufacturer 40 opens the editor 68 (step 820). To open the editor 68, the manufacturer may use a menu in the GUI 62, and select to open the editor 68 from the menu using, for example, a mouse click or a keyboard entry. When the editor 68 is opened, a window opens in the GUI 62 through which the manufacturer 40 can enter information to store in the database 66.

With the editor 68 open, the manufacturer 40 can enter product information for one or more products (step 830). The product information may include an image of the product, cost or pricing information, a description of the product including size, colors, weight and other features of the product, and any customizable features of the product. The information included for the product may include not only information the content developer 20 would need when deciding whether or not to purchase the item, but also information the content developer 20 may use to help persuade an approval group 50 to approve the purchase. Accordingly, the product information may include a narrative description of the utility of the product for some purpose, such as for educational or training purposes.

The manufacturer 40 then determines what content in the database 66 to associate with the product information (step 840). The product information may be associated with content that is relevant to the product that the information describes. For example, a manufacturer 40 selling a textbook on how to use XML may be relevant to content relating to databases, markup languages or even software in general. Alternatively, the manufacturer 40 may want to associate the product information with content that the manufacturer 40 believes to be relevant to a type of content developer 20 that would view or use such content. For example, the manufacturer 40 selling trips to Europe may want to associate the information describing the trips with content relating to France, as well as content relating to travel.

To identify the content with which to associate the product information, the manufacturer 40 may submit a query to the database 66. The query may include search terms relating to content areas for which the manufacturer 40 wants to associate the product information. For example, the manufacturer 40 of the textbook on how to use XML may submit search terms such as XML, databases, or markup languages. In response to the query, a list of content is shown to the manufacturer 40. The list displays content corresponding to the search terms of the query. The manufacturer 40 then identifies which pieces of content from the list to associate with the product information.

To associate the identified pieces of content with the product information, the manufacturer 40 associates attributes with the product information (step 850). The attributes include information about what content in the database 66 is associated with the product information. For example, if the manufacturer 40 wanted the textbook on how to use XML associated with a piece of content on databases, the attributes associated with the product information for the textbook may include the title or author of the piece of content, or some other attribute of the piece of content that ties the piece of content to the product information so that the selection of the piece of content by the content developer 20 would result in the recognition by the CMED system 60 of the relationship to the product information and the display of the product to the content developer for possible purchase.

Another way to associate a piece of content with the product information is to include a standards attribute for the product information. For example, if the product is relevant to a curriculum for a class in a particular grade level in K-12, the manufacturer 40 may associate a standards attribute with the product information that is applicable to the class for the particular grade level. As discussed above, if the database 66 is implemented in XML, then the attributes of the product information may be stored as tags.

After the product information has been entered and associated with attributes, the product information and the attributes are stored in the database 66 (step 860). The manufacturer may effect the storage of the product information and the attributes in the database with a mouse click on a menu item in the GUI 62 or with a keyboard entry. The database 66 transforms the product information and attributes entered in the editor 68 into a structure for storage in the database 66. Alternatively, a conventional catalog database may be converted “en masse” through a process whereby the product information is mapped from the catalog's database schema into the CMED data model.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for automating an approval process for a request for purchase, comprising:
receiving a search query for identifying content from a database;
identifying products available for purchase from the content in the database based on the search query;
receiving an indication to purchase at least one of the identified products;
creating a request for purchase for each of the at least one of the identified products;
transmitting the request for purchase to an approval organization; and
receiving an indication of whether the request for purchase was approved by the approval organization.

2. A method according to claim 1, wherein the creating of the request for purchase includes information regarding a cost for the purchase and information regarding the type of product.

3. A method according to claim 2, further comprising:
determining to which of a plurality of approval organizations to transmit the request for purchase based upon at least one of the cost information and the product type information.

4. A method according to claim 1, further comprising:
associating a national content standard with each piece of content stored in the database and with each product,
wherein the identifying of the products includes determining which products are associated with the national standard that is associated with the selected content.

5. A method according to claim 1, further comprising including the content identified in the search query in an instructional material.

6. A method according to claim 5, wherein identifying products includes displaying an icon corresponding to each product available for purchase.

7. A method according to claim 6, wherein receiving an indication to purchase includes:
clicking on the icon corresponding to at least one of the identified products; and
dragging the icon into a workspace of a graphical editing tool in which an instructional material is being developed.

8. A method according to claim 7, further comprising:
establishing a link between the icon corresponding to at least one of the identified products and a piece of content in the instructional material.

9. A computer readable medium operable on a computer system for automating an approval process for a request for purchase, the computer readable medium configured to:
automate an approval process for a request for purchase, comprising:
receive a search query for identifying content from a database;
identify products available for purchase from the content in the database based on the search query;
receive an indication to purchase at least one of the identified products;
create a request for purchase for each of the at least one of the identified products;
transmit the request for purchase to an approval organization; and
receive an indication of whether the request for purchase was approved by the approval organization.

10. A computer readable medium according to claim 9, wherein the request for purchase includes information regarding a cost for the purchase and information regarding the type of product.

11. A computer readable medium according to claim 10, further configured to determine to which of a plurality of approval organizations to transmit the request for purchase based upon at least one of the cost information and the product type information.

12. A computer readable medium according to claim 9, further configured to:
associate a national content standard with each piece of content stored in the database and with each product; and
determine which products are associated with the national standard that is associated with the selected content.

13. A computer readable medium according to claim 9, further configured to include the content identified in the search query in an instructional material.

14. A computer readable medium according to claim 13, further configured to display an icon corresponding to each product available for purchase.

15. A computer readable medium according to claim 14, wherein further configured to:
click on the icon corresponding to at least one of the identified products; and
drag the icon into a workspace of a graphical editing tool in which an instructional material is being developed.

16. A computer readable medium according to claim 15, further configured to establish a link between the icon corresponding to at least one of the identified products and a piece of content in the instructional material.

17. A computer system for automating an approval process for a request for purchase, the computer system comprising:
a processor; and
a memory which stores a plurality of instructions executed by the processor, the plurality of instructions configured to:
automate an approval process for a request for purchase, comprising:
receive a search query for identifying content from a database;
identify products available for purchase from the content in the database based on the search query;
receive an indication to purchase at least one of the identified products;
create a request for purchase for each of the at least one of the identified products;
transmit the request for purchase to an approval organization; and
receive an indication of whether the request for purchase was approved by the approval organization.

18. A computer system according to claim 17, wherein the request for purchase includes information regarding a cost for the purchase and information regarding the type of product.

19. A computer system according to claim 18, further comprising an instruction configured to determine to which of a plurality of approval organizations to transmit the request for purchase based upon at least one of the cost information and the product type information.

20. A computer system according to claim 17, further comprising instructions configured to:
associate a national content standard with each piece of content stored in the database and with each product; and
determine which products are associated with the national standard that is associated with the selected content.

21. A computer system according to claim 17, further comprising an instruction configured to include the content identified in the search query in an instructional material.

22. A computer system according to claim 21, further comprising an instruction configured to display an icon corresponding to each product available for purchase.

23. A computer system according to claim 22, wherein further comprising instructions configured to:
click on the icon corresponding to at least one of the identified products; and
drag the icon into a workspace of a graphical editing tool in which an instructional material is being developed.

24. A computer system according to claim 23, further comprising an instruction configured to establish a link between the icon corresponding to at least one of the identified products and a piece of content in the instructional material.
